(19) United States
(12) Patent Application Publication
(10) Pub. No.: US 2018/0114477 A1
(43) Pub. Date: Apr. 26, 2018

(54) SEQUENCE AND TIMING CONTROL OF WRITING AND REWRITING PIXEL MEMORIES WITH SUBSTANTIALLY LOWER DATA RATE

(71) Applicant: Fusao Ishii, Pittsburgh, PA (US)

(72) Inventor: Fusao Ishii, Pittsburgh, PA (US)

(21) Appl. No.: 15/275,405

(22) Filed: Sep. 25, 2016

(51) Int. Cl. G09G 3/20; G09G 5/10; G09G 5/06

(52) U.S. Cl. CPC G09G 3/2014; G09G 5/10; G09G 2360/00; G09G 2330/021; G09G 5/06

(57) ABSTRACT

A Display system driven with binary pulse-width-modulation requires very high data transfer rate to achieve high grayscale. This invention discloses the embodiments of hardware structures and configurations which enable to reduce substantially the data transfer rate using non-sequential order of binary bits, wherein the combination of the sequences of binary bits is selected from the combinations which avoid simultaneous writing of multiple rows. The implementation of this invention substantially reduces the power consumption and the number of connecting pads of display chip

### CROSS REFERENCE TO RELATED APPLICATIONS

This application is a Non-Provisional Application and a Continuation in Part (CIP) patent application Ser. No. 12/590,372 filed on Nov. 6, 2009 and issued into U.S. Pat. No. 8,228,595B2. This application was previously filed as a Provisional Application 61/853,713 on Apr. 10, 2013. This Patent Application is also a Continuation in Part (CIP) Application of patent application Ser. No. 11/183,216 filed on May 8, 2007 and issued into U.S. Pat. No. 7,215,460 B2. This application is also a Continuation in Part (CIP) Application of pending U.S. patent application Ser. No. 10/698,620 filed on Nov. 1, 2003, patent application Ser. No. 10/699,140 filed on Nov. 1, 2003 issued into U.S. Pat. No. 6,862,127, and patent application Ser. No. 10/699,143 filed on Nov. 1, 2003 issued into U.S. Pat. No. 6,903,860 by the Applicant of this Patent Applications. The disclosures made in these Patent Applications are hereby incorporated by reference in this Patent Application.

### TECHNICAL FIELD

This invention relates to display device includes control circuit to receive digital image signals and applies the digital image signals to control the image display. More particularly, this invention relates to signal control methods for controlling the non-sequential order and timing of inputting state signals to achieve substantially lower data transfer rate and substantially lower power consumption of both the display device and the controller with substantially lower number of IC pads.

### BACKGROUND OF THE INVENTION

Even though there are significant advances made in recent years on the technologies of implementing spatial light modulator, there are still limitations and difficulties when employed to provide high quality images display. Specifically, when the display images are digitally controlled, the image qualities are adversely affected due to the fact that the image is not displayed with sufficient number of gray scales. A higher input data rate is required in order to increase the number of gray scales to display the images with sufficient number of gray scales.

For the purpose of illustration, FIG. 1 shows High Definition (HD) display pixel array having 1920 columns and 1080 rows. Each pixel has at least one pixel memory, so that it can memorize image signal and drive the pixel and maintain the state of pixel until next writing cycle. Each column has a column driver which sends image signal to a pixel in a selected row in the column. Each row has a row driver and the row driver raises word-line (row-line) voltage so that the memory in the pixel in the selected row and the column will be written. Because of this structure, only one pixel in a row and a column can be written at a time by the column driver. Usually there are as many column drivers as the number of columns. Therefore full set of column drivers can write all pixels in a row at a time, but cannot write 2 or more rows at a time.

Conventional technology is to write pixel memories in a sequential order for both spatial and temporal orders, meaning that pixels in a column will be written from row 1 through row 1080 (spatial sequential order) and MSB (most significant bit) through LSB (least significant bit) as shown in FIG. 2 in temporal sequential order. FIG. 3 is an example of digital image data representing 10101001 in 8 bit binary code or 169 in decimal. When this first data (1 or ON of MSB) is sent to a pixel memory, the column driver sends ON volt to column line (bit-line) at the beginning and the memory in the selected row and the column where the column driver is connected will receive the ON volt signal and the voltage is memorized in the memory. Then after the duration of time of MSB which is 128 times LSB, the data representing D1 (the second most significant bit, in this case 0 or OFF) will be sent by the column driver to the pixel memory, so that the pixel is driven and maintain 1 or ON state for MSB time. Then after the duration of 2^{nd} MSB time (D1 time or ½ of MSB time), the next data (D2, 1 or ON) are then written into the memory.

FIG. 4 shows that the actual writing time is very limited. In spite of plenty of non-writing time, the speed required to write these signals is extremely high, because of the concentration of writing signals in a short period to write LSB. According to the conventional method of sequential writing as illustrated in FIG. 5, all the pixels in a column have to be written within a LSB period so that the next data can be written right after LSB. In case of full HD display having 1920 columns and 1080 rows with color sequential display meaning that a pixel will emit or reflect or transmit multiple colors changing at high speed enough for human eyes not to recognize the color change using digital 8 bit grayscale, the image data24 of 95,551,488,000 bits (=1920×1080(pixels) ×60 (frames per second)×3 (colors)×256 (=2^8, 8 bit grayscale)) have to be sent to the pixel array within a second. This translates to 95.551 Giga-bits have to be sent the pixel array in a second. This is a significantly high speed data transfer even with the latest technology. An example to embody this application is 128 channels of LVDS (low voltage differential signal transfer method) with 800 Mbps per channel. This is very high power consuming circuit as well as substantially high number of IC connection pads which are very costly. The present TV broadcasting for High Definition TV or HDTV is called as “2K”, because the pixel array consists of 1920×1080 or about 2K×1K pixel array. Recently, two new display formats were proposed and they are called “4K” and “8K”. 4K is 3840×2160 pixel array with 8 million pixels, and 8K is 7680×4320 pixel array with about 32 million pixels. The present 2K digital micromirror chip has about 400 IC pads and its controller chip has about 500 IC pads. If the number of pads is proportional to the number of pixels, the numbers of IC pads for 4K and 8K chips can be 1600 and 6400. These are not practically possible and will be very expensive, even if they are implemented.

For these reasons, there are urgent demand to provide new and improved configuration and methods to overcome such difficulties and limitations. Some algorisms were disclosed in U.S. Pat. No. 8,228,595B2 filed by the Applicant by this Application and substantial power reduction as well as simplified circuits are achieved by implementing the methods and apparatuses disclosed in U.S. Pat. No. 8,228,595B2. The disclosures in U.S. Pat. No. 8,228,595B2 are hereby incorporated by reference in the Application. In the meantime, further improvements are also discovered and are disclosed in the present invention to provide additional new inventive features to further improve the image display system.

### SUMMARY OF THE INVENTION

The present inventions provide hardware structures from display devices through control circuits using the digital image data processing methods proposed in the patent, U.S. Pat. No. 8,228,595B2. The purpose of this invention is to apply such methods to spatial light modulators (SLMs) and displays using binary digital pulse width modulation to control grayscale to achieve substantially lower power and less number of IC connection pads.

The present inventions also provide method to control the image display system to achieve the reduction of artifacts of digital image displays.

### BRIEF DESCRIPTION OF THE FIGURES

FIG. 1 shows High Definition (HD) display pixel array having 1920 columns and 1080 rows.

FIG. 2 shows the conventional technology that writes pixel memories in a sequential order for both spatial and temporal orders, wherein the pixels in a column will be written from row 1 through row 1080 (spatial sequential order) and MSB (most significant bit) through LSB (least significant bit).

FIG. 3 shows an example of digital image data that represents 10101001 in 8 bit binary code or 169 in decimal.

FIG. 4 shows that the actual writing time is very limited in spite of plenty of non-writing time, the speed required to write these signals is extremely high, because of the concentration of writing signals in a short period to write LSB.

FIG. 5 shows method of sequential writing as illustrated wherein all the pixels in a column have to be written within a LSB period so that the next data can be written right after LSB.

FIG. 6 shoes the use of non-sequential order of image data writing of this invention that uses both spatial and temporal non-sequential order and instead of writing full rows in a sequence, after writing MSB data for partial rows, the system returns to the first row and write the 2^{nd} MSB thus reducing the LSB time substantially.

FIG. 7A shows an example of sequential data writing. FIG. 7B is an example of non-sequential data writing. FIG. 7C shows an example to write both the datum in FIG. 7A and FIG. 7B are written in the same time period.

FIG. 8 shows an embodiment of this invention with non-sequential writing with reduced artifacts by reducing the MSB time unit by half.

FIG. 9 shows an example of embodiments of this invention, display device (101) and controller (105) having a look up table (107) containing a sequence of data writing based on this invention.

FIG. 10 illustrates an example of this invention wherein display device (101) containing a look up table (107) internally.

FIG. 11 illustrates an example of this invention wherein a look up table (107) is included in a display controller (105), which receives signal data and transfer the signal data to the display device.

FIG. 12 illustrates an example of this invention wherein a look up table (107) and display controller (105) are included in a display device (101).

FIG. 13 illustrates an example of this invention wherein a look up table (107) and display controller (105) and frame memory(108), which memorizes the incoming video signal data, are included in a display device.

FIG. 14 illustrates a comparison between conventional data writing sequence and this invention's sequence.

FIG. 15 illustrates a comparison among various types of data writing. The conventional model using sequential data writing shows high power consumption and the models incorporating this method show dramatic power reduction.

FIG. 16 illustrates a comparison among various types of data writing. The conventional model using sequential data writing shows high number of IC pads as well as high power consumption and the models incorporating this method show dramatic reduction of power consumption and the number of IC pads.

FIG. 17 shows an actual projected image created by a device implementing a method of this invention that uses non-sequential algorism. No artifacts in the image are noticeable.

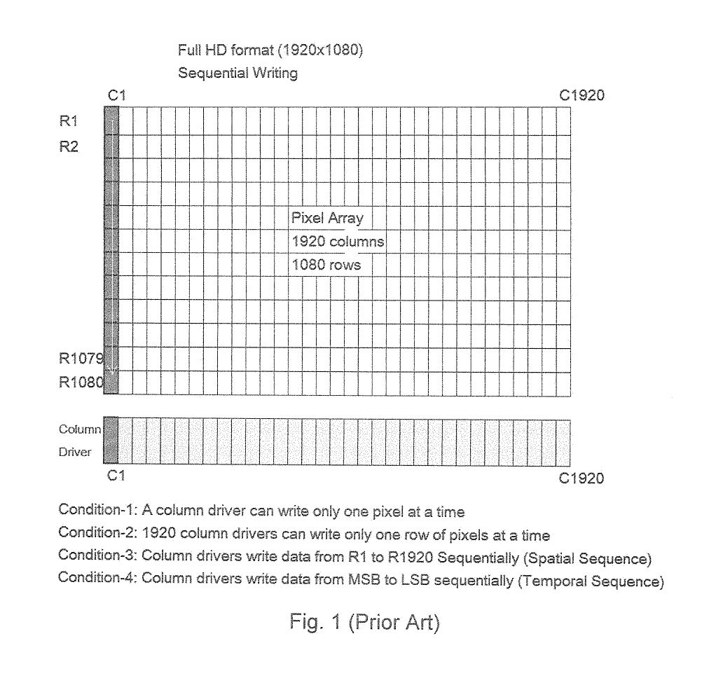

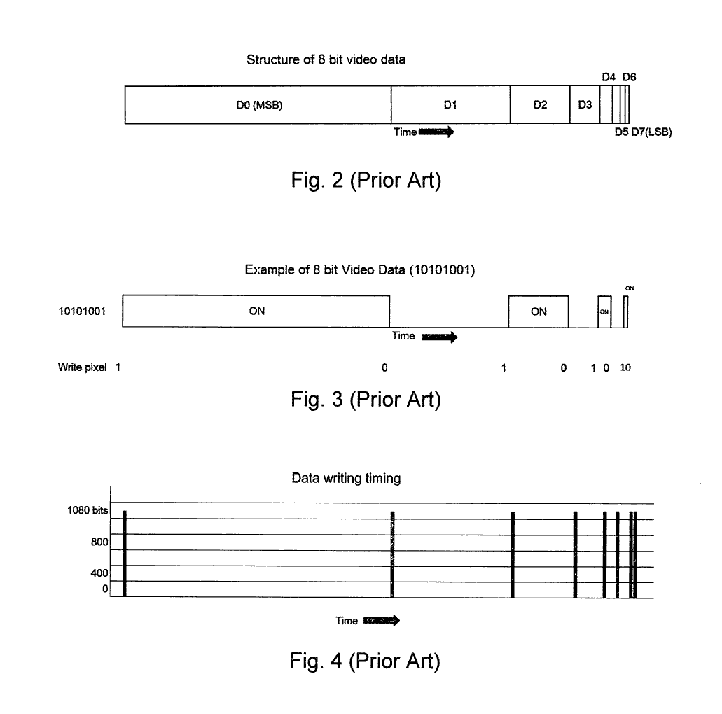

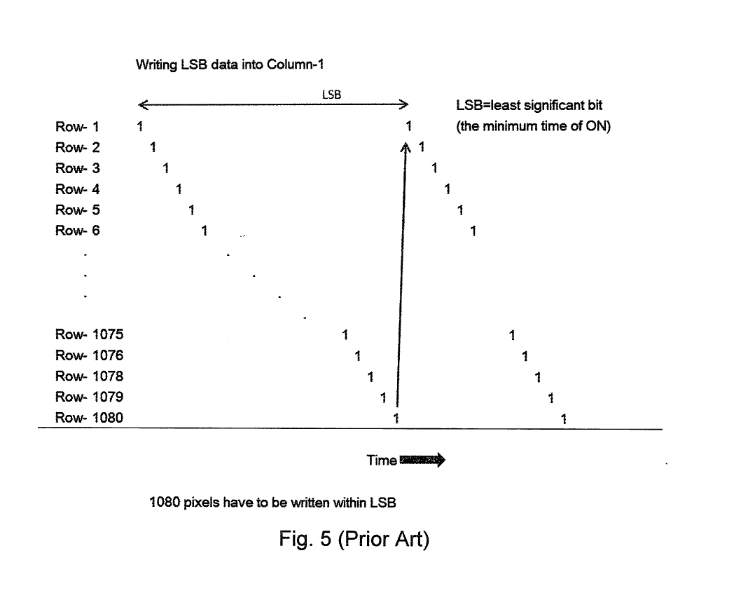

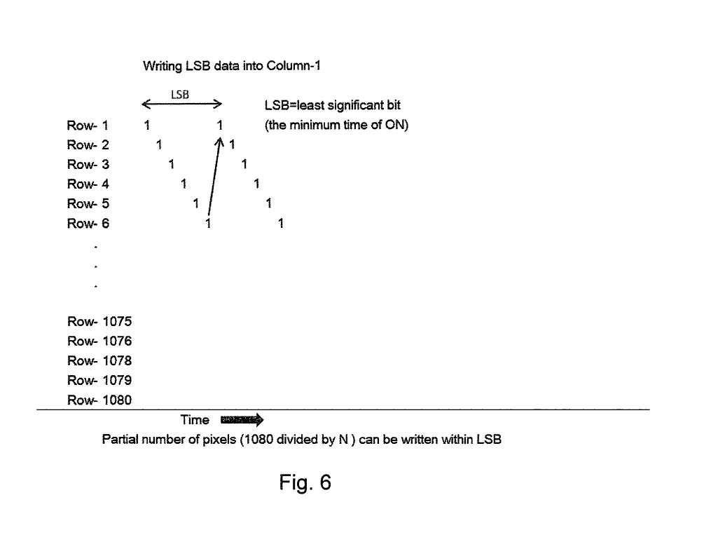

### DETAILED DESCRIPTION OF THE PREFERRED EMBODIMENTS

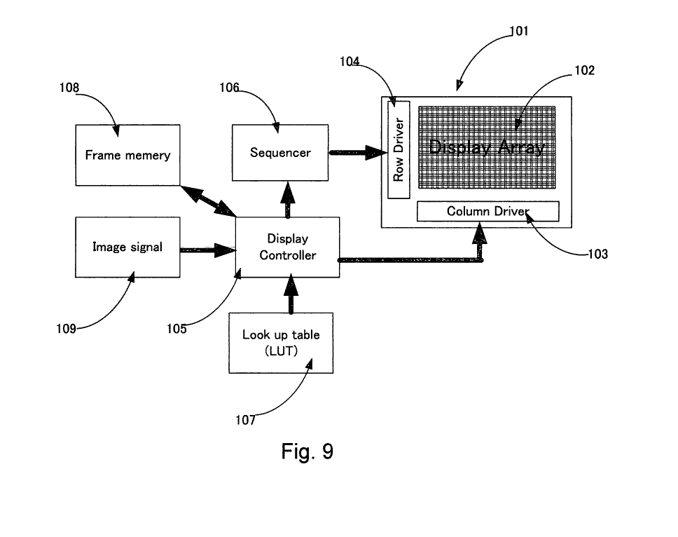

A display device (101) has a pixel array (102) as in FIG. 9. For example, if it is a HDTV, the array has 1920(horizontal)×1080(vertical) pixels in an array. Each pixel consists of a device which either emits light (plasma, OLED) or reflect light (LCOS, micromirror) or modulate light (LCD) to create images. A display device usually has a set of column drivers and row drivers. The column drivers send video signal to pixels in the row which a row driver selects. The signals sent by the column drivers will be transferred to pixels in the row. The system selects only one row at a time assuming there is no duplicated image in the display. The controller (105) in FIG. 9 controls which row should be chosen through sequencer (106) and transfer signals to the pixels in the row. The pixels which received the signals will either emits light (plasma, OLED) or reflects light (LCOS, micromirror) or modulate light (LCD) according to the signals. Because the incoming signals to the Image Signal unit (109) is sequential from top row to bottom row, the display controller also sends signals from top row to bottom row. The incoming signals are often in 3 colors parallel as HDMI and VGA. Depending on the type of display, it may require 3 colors parallel or each color sequential. If the display is a color sequential display, it requires each color sequentially. The timing of incoming signals and the timing of writing signals into pixels often do not match. There is a need of frame memory (108) storing the incoming signals to adjust timing and/or sequence of signals between incoming signals and display device. On top of these, this invention requires a memory which stores the sequence of rows and the orders of data bits to write signals into pixels. We call this memory Look-Up-Table(LUT) as (107) in FIG. 9. The sequence of row and data bits has to be stored in the LUT.

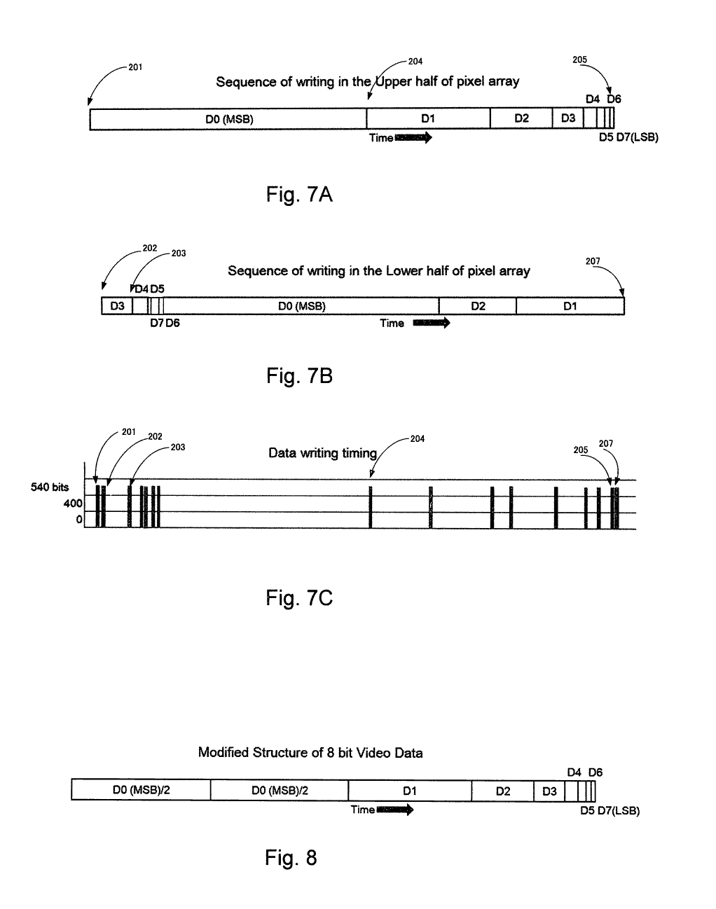

FIG. 7A, B and C illustrate an example showing a sequential writing (FIG. 7A) and a non-sequential data writing in time domain (temporal non-sequential order of data writing, FIG. 7B) and both writings are implemented in a same period (FIG. 7C). Typical order to write data is from MSB through LSB as FIG. 7A and FIG. 7B is an example of non-sequential. FIG. 7A shows the timing of data writing. 201 is the time to write D0 (MSB) and 204 is the time to write D1 and 205 is the time to write the end of LSB. FIG. 7B shows an example to write the video data (D0 through D7) in non-sequential order. Assuming that the system will write video data in the upper half of pixel array in the order of FIG. 7A and write data in the lower half of pixel array in the order of FIG. 7B, it can be shown that both the datum in FIG. 7A and FIG. 7B can be written during the same time period. In the upper half of the pixel array, the first data is written at 201 then the second data is written at 204. The time period between 201 and 204, no data is written into the upper array. This means that the bit lines are available to write data into the lower array. As shown in FIG. 7B, the data D3(202), D4(203), D5,D7 and D6 in FIG. 7B can be written before the next time (204) to write data into the upper array. Thus, both upper and lower halves of array can be written during the same time period. This means that the entire pixel array can be written in half time of sequential order. If we divide the entire array into N blocks and if we can write data into each block without conflicts, the entire array can be written in 1/N of time period of the conventional sequential writing. This means that we can transfer N times more data within the same time period. This is the basic principle of this algorism (we named this algorism High Speed Video Data Transfer or HSVT). To enable this, we need to write rows in non-sequential order (Spatial Non-Sequential Order), because we switch rows between the upper and the lower array.

FIG. 9 illustrates an example of embodiments using an external controller chip (105), a Look-Up-Table(LUT), a frame memory(108) and a unit (109) to receive incoming signal and transfer to the controller. The image signal unit (109) transfers incoming signal to the controller (105). The signal must be digital. If the incoming signal is analog such as VGA, the signal must be converted to digital. If the signal is digital as HDMI or DVI, these can be stored in the frame memory (108) . As described before, the incoming timing of each signal often does not match the need by the display device (101). This problem can be resolved by adding a frame memory which stores the entire data of frame(s), so that the display controller can adjust timing of data transfer to the display device (101).

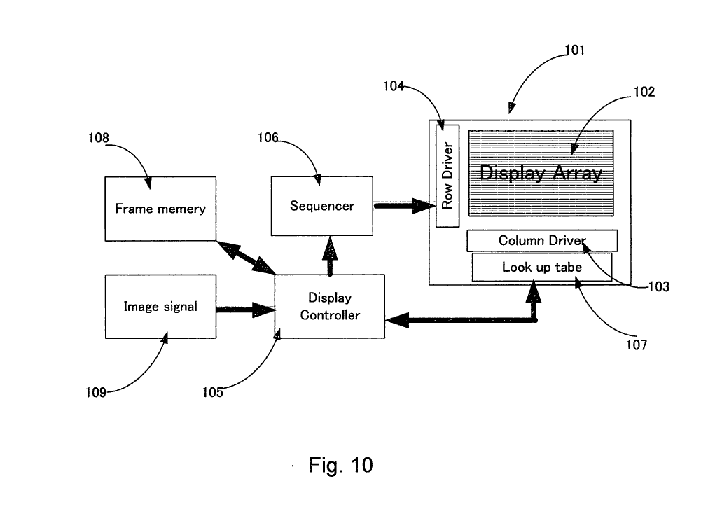

FIG. 10 illustrates an example of embodiments using an external controller chip (105), an external frame memory and an internal look-up-table which resides inside the display device. This will reduce the burden of the display controller (105).

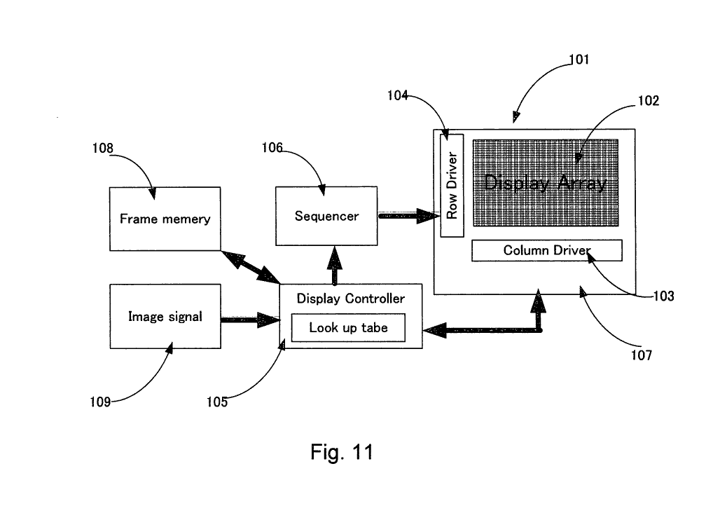

FIG. 11 illustrates an example of embodiments using an external controller chip (105), wherein a look-up-table is embedded inside the controller.

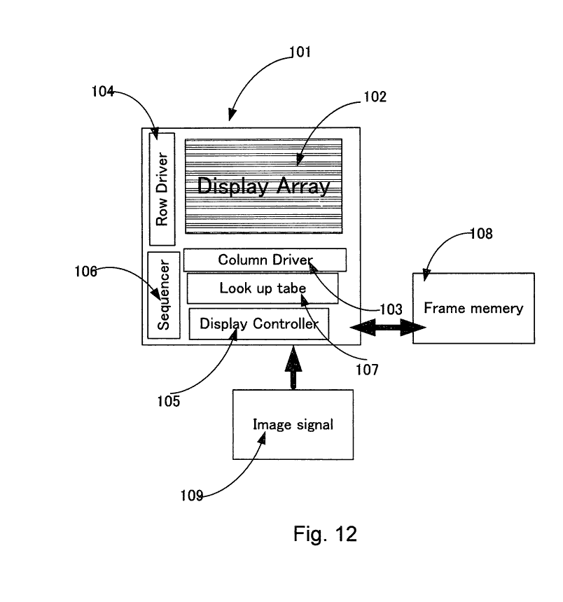

FIG. 12 illustrates an example of embodiments using an external controller chip (105), wherein a look-up-table is embedded inside the controller.

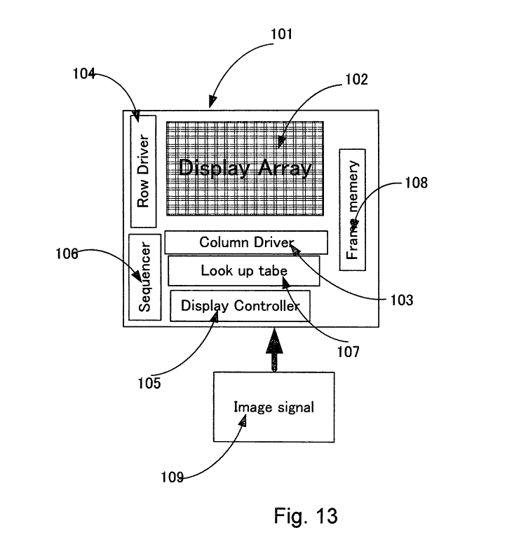

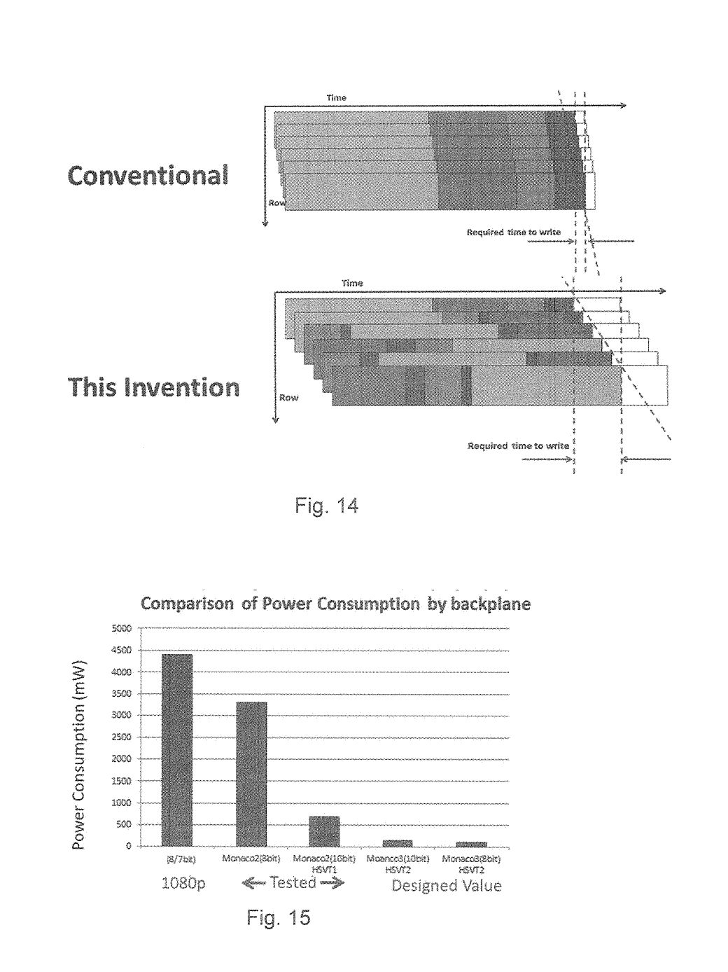

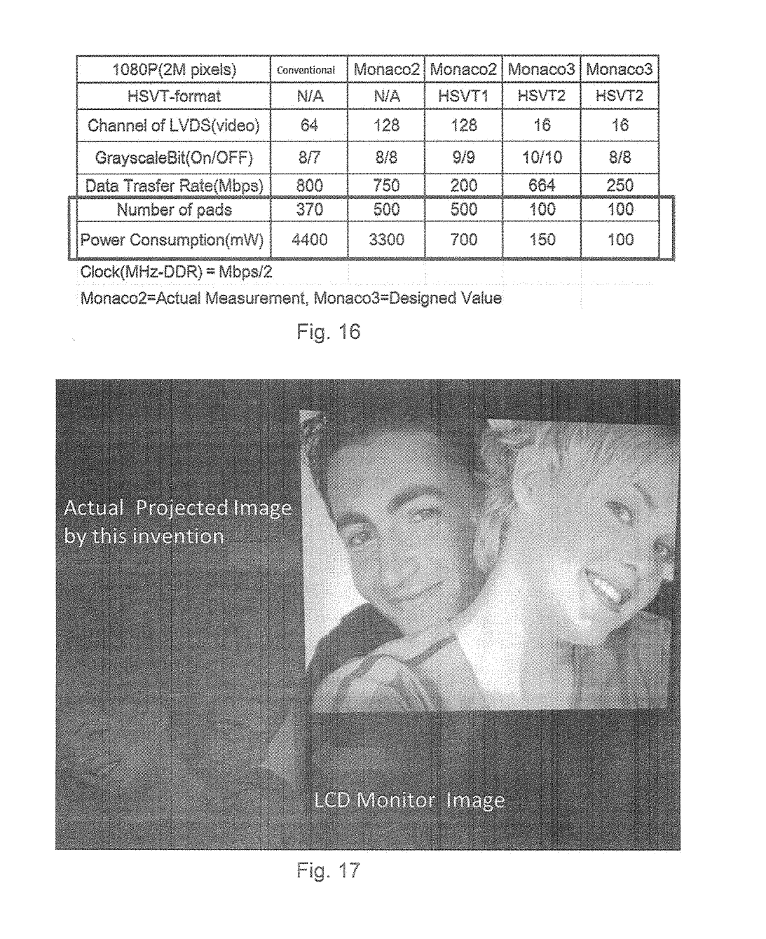

FIG. 13 illustrates an example of embodiments using an internal controller chip (105), internal look-up-table (107), an internal frame memory and internal sequencer inside the display device.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An image display system having a plurality of pixel elements to receive and apply digital image data of multiple bits to display image according to the digital image data, the image display system further comprising:
a controller to control a process of writing the digital image data into each of the pixel elements by dividing the image data of multiple bits into a plurality of groups and writing each group of bits into the pixel element in a non-sequential order that is unrelated to a significance order of bit, neither in an order of from a most significant bit (MSB) to a least significant bit (LSB) nor from the LSB to the MSB, and without a writing conflict in writing said memory data into two pixel elements simultaneously during a process of writing and a look up table containing at least one set of sequences of data writing for said display system.

2. The image display system of claim 1 wherein:
said look up table comprises look-up data stored in a non-volatile memory.

3. The image display system of claim 2 wherein:
said look up table is separate from display device

4. The image display system of claim 1 wherein:
said look up table is embedded inside display device

5. The image display system of claim 1 wherein:
the display controller and look-up-table are included as an integrated part of the display device

6. The image display system of claim 1 wherein:
the pixel elements in each of the rows are divided into groups including interleaved lines

7. An image display system having a plurality of pixel elements to receive and apply digital image data of multiple bits to display image according to the image data, the image display system further comprising:
a controller to control a process of writing the image data into each of the pixel elements by dividing the image data of multiple bits into groups and writing each group of bits into the pixel element in a non-sequential order of significance of bit, neither in an order of from a most significant bit (MSB) to a least significant bit (LSB) nor from the LSB to the MSB, and without a writing conflict in writing said memory data into two pixel elements simultaneously during the process of writing and high significance bits including MSB are subdivided into at least two units.

8. The image display system of claim 7 wherein:
a look up table containing data defining at least one set of sequences of writing the image data for said display.

9. The image display system of claim 7 wherein:
the pixel elements in each of the rows are divided into groups including interleaved lines.

10. An image display system having a plurality of pixel elements to receive and apply digital image data of multiple bits to display image according to the image data, the image display system further comprising:
a controller to control a process of writing the image data into each of the pixel elements by dividing the image data of multiple bits into groups and writing each group of bits into the pixel element in a non-sequential order of significance of bit, neither in an order of from a most significant bit (MSB) to a least significant bit (LSB) nor from the LSB to the MSB, and without a writing conflict in writing said memory data into two pixel elements simultaneously during the process of writing; and
said controller is made of FPGA.
